(19) United States
(12) Patent Application Publication
(10) Pub. No.: US 2023/0234229 A1
(43) Pub. Date: Jul. 27, 2023

(54) SYSTEMS AND METHODS OF COORDINATED BODY MOTION OF ROBOTIC DEVICES

(71) Applicant: Boston Dynamics, Inc., Waltham, MA (US)

(72) Inventors: Gina Fay, Lexington, MA (US); Navid Aghasadeghi, Boston, MA (US); Alfred Anthony Rizzi, Belmont, MA (US)

(73) Assignee: Boston Dynamics, Inc., Waltham, MA (US)

(21) Appl. No.: 17/994,855

(22) Filed: Nov. 28, 2022

Related U.S. Application Data
(60) Provisional application No. 63/301,842, filed on Jan. 21, 2022.

(51) Int. Cl. B25J 9/16

(52) U.S. Cl. CPC B25J 9/1666; B25J 9/162; B25J 9/1676; B25J 9/1661

(57) ABSTRACT

Techniques are described that determine motion of a robot's body that will maintain an end effector within a useable workspace when the end effector moves according to a predicted future trajectory. The techniques may include determining or otherwise obtaining the predicted future trajectory of the end effector and utilizing the predicted future trajectory to determine any motion of the body that is necessary to maintain the end effector within the useable workspace. In cases where no such motion of the body is necessary because the predicted future trajectory indicates the end effector will stay within the useable workspace without motion of the body, the body may remain stationary, thereby avoiding the drawbacks caused by unnecessary motion described above. Otherwise, the body of the robot can be moved while the end effector moves to ensure that the end effector stays within the useable workspace.

### CROSS REFERENCE TO RELATED APPLICATIONS

This application claims the benefit under 35 U.S.C. § 119(e) of U.S. Provisional application 63/301,842, filed Jan. 21, 2022, and entitled, “SYSTEMS AND METHODS OF COORDINATED BODY MOTION OF ROBOTIC DEVICES,” the disclosure of which is incorporated by reference in its entirety.

### BACKGROUND

A robot is generally a reprogrammable and multifunctional manipulator, often designed to move material, parts, tools, or specialized devices through variable programmed motions for performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

Some robots have articulated arms that may be operated to perform a variety of tasks by operating motorized joints of the arm. Such arms may have a device at the end of the arm, often referred to as an “end effector,” designed to interact with the environment and that can be moved around in the environment by operating the arm. The nature of the end effector depends on the type of robot, but may include grippers such as jaws, as well as tools. Grippers may have a variety of gripping surfaces, such as jaws, claws, or mechanical fingers. In some cases, end effectors may be used to perform constrained tasks, which are tasks which by their nature constrain the motion of the end effector to a particular path, such as a task of opening a door or turning a crank.

### SUMMARY

According to some aspects, a method is provided of controlling a robot comprising a body and an end effector coupled to the body, the method comprising using at least one processor obtaining a current pose of the body and a predicted future trajectory of the end effector, determining, based at least in part on the current pose of the body and the predicted future trajectory of the end effector, a motion of the body that will maintain the end effector within a useable workspace, and controlling the body to perform the motion.

According to some implementations, obtaining the predicted future trajectory comprises determining the predicted future trajectory based on data indicating one or more prior poses of the end effector.

According to some implementations, the one or more prior poses of the end effector are represented by data previously measured by the robot.

According to some implementations, the method further comprises determining the predicted future trajectory by fitting the data indicating the one or more prior poses of the end effector to a line, circle, or curve.

According to some implementations, the method further comprises determining the predicted future trajectory based on a type of task currently being performed.

According to some implementations, the predicted future trajectory is determined under an assumption that a velocity of the end effector is constant.

According to some implementations, the method further comprises reducing a velocity of the end effector in response to determining that controlling the body to perform the motion while the end effector moves according to the predicted future trajectory will not maintain the end effector within the usable workspace.

According to some implementations, determining the motion of the body that will maintain the end effector within the useable workspace comprises determining motion of the body that meets a first steering objective when the end effector is moved along the predicted future trajectory.

According to some implementations, the first steering objective constrains a pose of the end effector relative to a pose of the body and/or constrains an angle of at least one of the one or more joints of an articulated arm that couples the end effector to the body.

According to some implementations, the first steering objective constrains the pose of the end effector relative to the pose of the body to avoid hyperextension of the articulated arm.

According to some implementations, the first steering objective constrains the pose of the end effector relative to the pose of the body to avoid collisions between the end effector and the body.

According to some implementations, determining the motion of the body that will maintain the end effector within the useable workspace further comprises determining motion of the body that meets a second steering objective, different from the first steering objective, when the end effector is moved along the predicted future trajectory.

According to some implementations, determining the motion of the body that will maintain the end effector within the useable workspace comprises combining the determined motion of the body that meets the first steering objective with the determined motion of the body that meets the second steering objective.

According to some implementations, the method further comprises determining the predicted future trajectory of the end effector while controlling motion of the end effector.

According to some implementations, the method further comprises determining the predicted future trajectory based on a pose of the end effector and based on data describing an environment proximate to the end effector.

According to some implementations, the method further comprises determining the predicted future trajectory based on a projected task.

According to some implementations, the predicted future trajectory comprises a plurality of points in SE(3) space.

According to some implementations, the determined motion of the body that will maintain the end effector within the useable workspace comprises a plurality of points in SE(2) space.

According to some implementations, the determined motion of the body that will maintain the end effector within the useable workspace is determined based on a pose of the end effector and/or a current velocity of the end effector.

According to some implementations, the method further comprises measuring a current velocity of the end effector.

According to some implementations, determining the motion of the body is further based on output from a collision avoidance system.

According to some implementations, the robot further comprises an articulated arm coupling the end effector to the body and having one or more joints.

According to some implementations, determining the motion of the body that will maintain the end effector within the useable workspace comprises determining the motion of the body that will maintain the end effector within the useable workspace when the end effector is moved along the predicted future trajectory.

According to some implementations, controlling the body to perform the motion comprises controlling the body to perform the motion while the end effector moves according to the predicted future trajectory.

According to some aspects, a mobile robotic device is provided, comprising a body, an end effector coupled to the body, and at least one controller configured to obtain a current pose of the body and a predicted future trajectory of the end effector, determine, based at least in part on the current pose of the body and the predicted future trajectory of the end effector, a motion of the body that will maintain the end effector within a useable workspace, and control the body to perform the motion.

According to some implementations, the at least one controller is further configured to obtain the predicted future trajectory by determining the predicted future trajectory based on data indicating one or more prior poses of the end effector.

According to some implementations, the mobile robotic device further comprises at least one computer readable storage medium, and the one or more prior poses of the end effector are represented by data previously measured by the robot and recorded on the at least one computer readable medium.

According to some implementations, the at least one controller is further configured to determine the predicted future trajectory by fitting the data indicating the one or more prior poses of the end effector to a line, circle, or curve.

According to some implementations, the at least one controller is further configured to determine the predicted future trajectory based on a type of task currently being performed.

According to some implementations, the at least one controller is further configured to reduce a velocity of the end effector in response to determining that controlling the body to perform the motion while the end effector moves according to the predicted future trajectory will not maintain the end effector within the usable workspace.

According to some implementations, determining the motion of the body that will maintain the end effector within the useable workspace comprises determining motion of the body that meets a first steering objective when the end effector is moved along the predicted future trajectory.

According to some implementations, the mobile robotic device further comprises an articulated arm that couples the end effector to the body, and the first steering objective constrains a pose of the end effector relative to a pose of the body and/or constrains an angle of at least one of the one or more joints of the articulated arm.

According to some implementations, the first steering objective constrains the pose of the end effector relative to the pose of the body to avoid hyperextension of the articulated arm.

According to some implementations, the first steering objective constrains the pose of the end effector relative to the pose of the body to avoid collisions between the end effector and the body.

According to some implementations, determining the motion of the body that will maintain the end effector within the useable workspace further comprises determining motion of the body that meets a second steering objective, different from the first steering objective, when the end effector is moved along the predicted future trajectory.

According to some implementations, determining the motion of the body that will maintain the end effector within the useable workspace comprises combining the determined motion of the body that meets the first steering objective with the determined motion of the body that meets the second steering objective.

According to some implementations, the at least one controller is further configured to determine the predicted future trajectory of the end effector while controlling motion of the end effector.

According to some implementations, the at least one controller is further configured to determine the predicted future trajectory based on a pose of the end effector and based on data describing an environment proximate to the end effector.

According to some implementations, the at least one controller is further configured to determine the predicted future trajectory based on a projected task.

According to some implementations, the predicted future trajectory comprises a plurality of points in SE(3) space.

According to some implementations, the at least one controller is further configured to measure a current velocity of the end effector.

According to some implementations, determining the motion of the body is further based on output from a collision avoidance system.

According to some implementations, the mobile robotic device further comprises an articulated arm coupling the end effector to the body and having one or more joints.

According to some implementations, determining the motion of the body that will maintain the end effector within the useable workspace comprises determining the motion of the body that will maintain the end effector within the useable workspace when the end effector is moved along the predicted future trajectory.

According to some implementations, the at least one controller is configured to control the body to perform the motion while the end effector moves according to the predicted future trajectory.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative robot according to some embodiments of the present disclosure;

FIGS. 2A-2C depict different strategies for moving an end effector and body of a robot, according to some embodiments;

FIG. 3 is a flowchart of a method of controlling a robot by determining a motion of the robot's body that will maintain the end effector within a useable workspace, according to some embodiments;

FIG. 4 depicts the position and orientation of an end effector in two dimensions, according to some embodiments;

FIGS. 5A and 5B depict two approaches to determining body motion to avoid arm hyperextension, according to some embodiments;

FIG. 6 depicts an approach to determining body motion to avoid end effector and body collisions, according to some embodiments;

FIG. 7 depicts an approach to determining body motion to avoid reaching a joint limit of an articulated arm, according to some embodiments;

FIG. 8 depicts an approach to determining body motion to avoid an end effector entering a “no-go” region, according to some embodiments;

FIG. 9 depicts an approach to determining body motion to align a heading of the body to motion of the end effector, according to some embodiments;

FIG. 10 is a schematic of a robotics system suitable for practicing embodiments of the present disclosure, according to some embodiments; and

FIG. 11 illustrates an example configuration of a robotic device, according to some embodiments.

### DETAILED DESCRIPTION

Some robots may include an end effector, such as a gripper, that can be operated to perform a task. During the task, one or more joints within an articulated arm may be controlled so that the end effector moves in a desired manner to perform the task. During such a task, movement of the articulated arm can sometimes encounter kinematic limitations, such as hyperextension of the arm or collision between the arm and another part of the robot, such as a body. These kinematic limitations may inhibit or preclude the task from being completed successfully.

In some cases, another part of a robot may be moved to accommodate the aforementioned kinematic limitations. For instance, a robot that includes a body and an articulated arm attached to the body may move the body in concert with the arm motion. In one such approach, sometimes called “follow the hand,” the body may be moved in the same manner as the end effector so that there is a fixed (or approximately fixed) spatial position and orientation between the end effector and the body. While this approach may avoid limitations such as hyperextension or collisions, such movement may be undesirable because the repeated and/or unnecessary movements of the body may lead to instability of the robot and/or may be less aesthetically pleasing.

Aspects of the present disclosure provide techniques to determine motion of a robot's body that will maintain an end effector within a useable workspace when the end effector moves according to a predicted future trajectory. The techniques may include determining or otherwise obtaining the predicted future trajectory of the end effector and utilizing the predicted future trajectory to determine motion of the body that will, and in some embodiments is necessary to, maintain the end effector within the useable workspace. In cases where no such motion of the body is necessary because the predicted future trajectory indicates the end effector will stay within the useable workspace without motion of the body, the body may remain stationary, thereby avoiding the drawbacks caused by unnecessary motion described above. Otherwise, the body of the robot can be moved while the end effector moves to ensure that the end effector stays within the useable workspace.

As used herein, a “useable workspace” may refer to the universe of relative positions and orientations between an end effector and a body of a robot that are not expected to impinge upon a task being performed. In some cases, a useable workspace may also include particular relative positions of different joints within an articulated arm that comprises the end effector (e.g., the universe of relative joint positions that avoid singularities such as gimbal lock). Different types of tasks may have different associated useable workspaces to reflect different constraints being present for each type of task. One way to specify a useable workspace is to conform operation of the robot to one or more steering objectives, as described below.

In some embodiments, maintaining an end effector within a useable workspace may include analyzing one or more steering objectives to determine motion of the body required to meet the one or more steering objectives. If no body motion is necessary to meet all the steering objectives as the end effector moves according to the predicted future trajectory, the robot body may be stationary while the end effector continues to move. Alternatively, analyzing the one or more steering objectives may determine motion of the body (which may include translations and/or rotations of the body) that is required to meet one or more of the steering objectives. In some cases, a plurality of steering objectives may be considered separately so that any calculated body motions are determined for each steering objective independently of any other steering objective. A plurality of body motions determined under the constraint of the steering objectives may then be combined to determine a resulting motion for the body.

As described above, determining whether motion of the robot's body is needed to maintain the end effector within a useable workspace may be based on a predicted future trajectory of the end effector. The predicted future trajectory may, for instance, be determined by fitting measured past positions and/or orientations of the end effector to a line or curve and extrapolating the line or curve into expected future positions and/or orientations of the end effector. These expected future positions and/or orientations of the end effector may be examined to determine whether the current position and/or orientation of the body will allow the end effector to remain within a useable workspace when it moves as expected.

Control of a robot may involve control around different rotational axes (e.g., pitch, roll, and yaw), in addition to translational movement (e.g., lateral, longitudinal, and vertical). Collectively, these different aspects of control form six degrees of freedom (DOF) in three dimensions. The position and orientation of a component of a robot such as a body or an end effector can then be described by six values in three-dimensional space that include three values describing a position and three values describing orientation around three different axes. The combination of these values may be referred to herein as a “pose,” which describes both position and orientation of a component (or reference point) of the robot. In two-dimensional space, a pose may also be described by three values—two position values and one orientation value. In some embodiments, a predicted future trajectory of an end effector may be based on a current pose of the end effector and/or based on a current pose of the body.

According to some embodiments, a robot may periodically perform a process of determining motion of the body that will maintain the end effector within a useable workspace when the end effector moves according to a predicted future trajectory. The motion of the body may be determined for some future period (e.g., 1 second), and the robot may be operated according to said motion of the body until the process of determining motion is performed again. The periodic determination of the motion of the body may occur more frequently (e.g., hundreds of times per second) than the duration of the planned motion of the body (e.g., the next 1 second of motion). Determining a predicted future trajectory of the end effector may be performed periodically (e.g., prior to each new determination of the motion of the body or at any other times). In this manner, the predicted future trajectory may be updated periodically and planned motion of the body may also be updated periodically as the end effector moves, resulting in a dynamic process of adjustment so that the robot can adapt to motion of the end effector to maintain the end effector within the useable workspace.

Following below is additional description of various concepts related to, and embodiments of, techniques for maintaining the end effector of a robot within a useable workspace. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

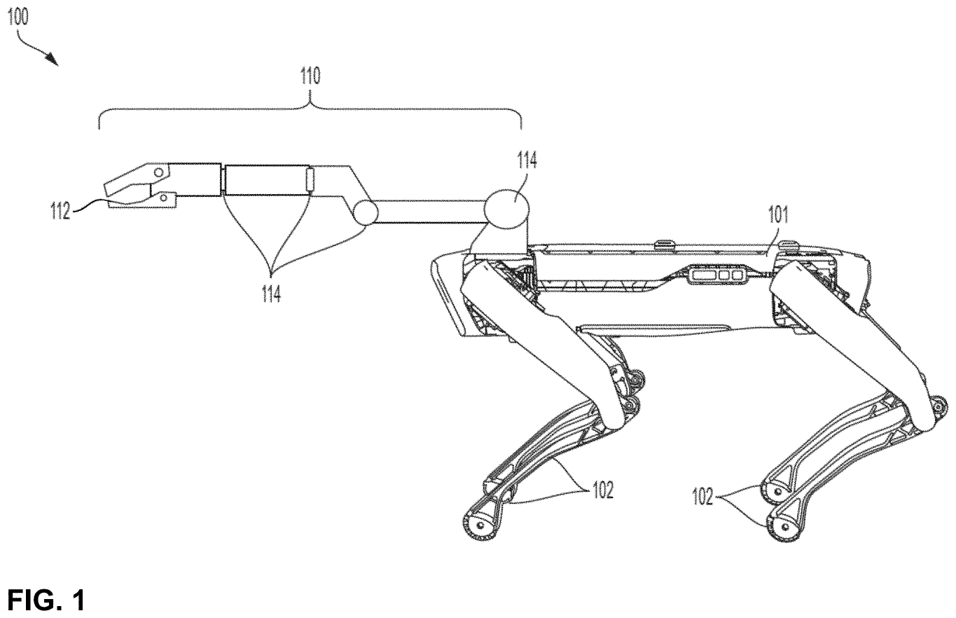

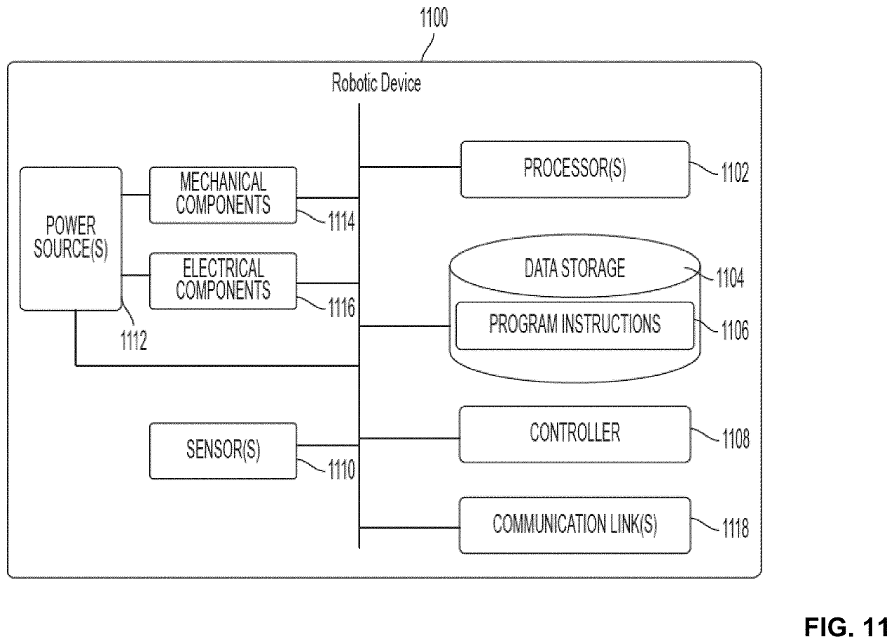

FIG. 1 depicts an illustrative robot according to some embodiments of the present disclosure. While the techniques described herein are not limited to any particular type of robot, for purposes of explanation an illustrative robot 100 is depicted in FIG. 1. In the example of FIG. 1, robot 100 includes a body 101 and an articulated arm 110, which includes a gripper 112 as an end effector, and joints 114. In the example of FIG. 1, robot 100 is configured as a quadruped robot, with the legs 102 coupled to the body 101 enabling the robot to move within an environment by controlling the configuration, position and/or structure of the legs. An illustrative system diagram that may represent some operational components of the robot 100 is described below in relation to FIG. 11.

As described above, motion of an end effector may encounter kinematic limitations that inhibit or preclude a task from being completed successfully. With respect to the illustrative robot of FIG. 1, for instance, it may be possible to operate the joints 114 such that the end effector 112 collides with the body 101 (or a leg 102), or the end effector may be moved to a hyperextended position away from the body 101 to which the articulated arm 110 is coupled. As described below, one or more controllers (e.g., processors) within the robot may perform a method of determining a motion of the body that will avoid such limitations as the end effector continues to move.

The example of FIG. 1 is provided for purposes of illustration, as the techniques described herein are not limited to any particular structure for an end effector, arm and body, nor to any particular kinematic limitations that may be encountered for a given robot. In addition, although the word “body” may be used throughout the present disclosure, it may be appreciated that this term may refer generally to a structure to which an articulated arm is directly or indirectly attached, and is not limited to a body like the one shown in FIG. 1. For example, a “body” can also include central structures within robots that move via means other than legs, such as via treads or tracks.

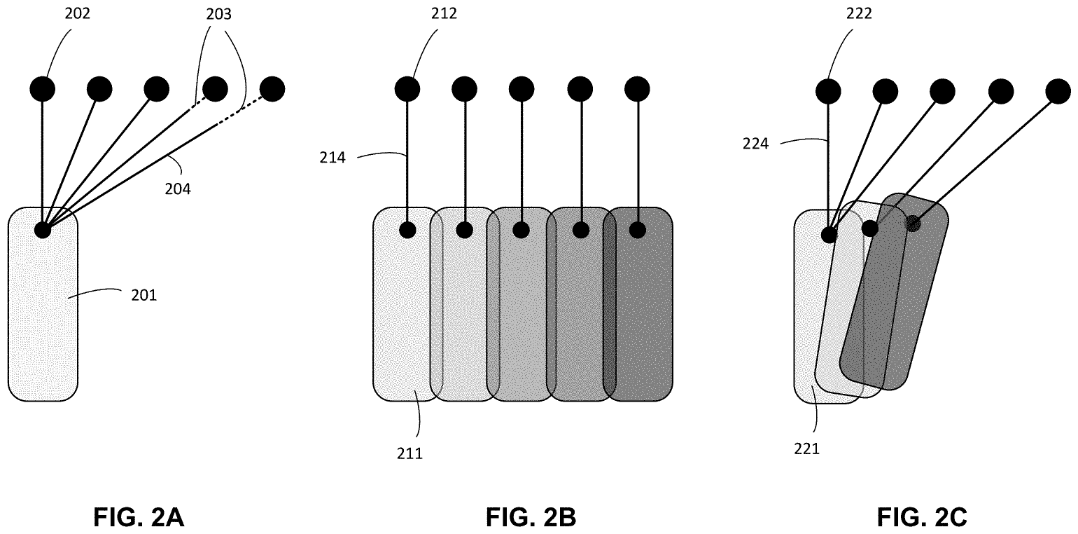

FIGS. 2A-2C depict different strategies for moving an end effector and body of a robot, according to some embodiments. To illustrate the advantages of the techniques described herein, two less desirable approaches represented by FIGS. 2A and 2B will be contrasted with FIG. 2C, which represents the techniques described herein. In each of FIGS. 2A-2C, a robot is represented pictorially by a body 201, 211, 221 (rounded rectangle) coupled to an end effector 202, 212, 222 (large black circle) via an articulated arm 204, 214, 224 (the line connecting the body to the end effector). In addition, in each of FIGS. 2A-2C, the end effector is moving from left to right over time, with multiple configurations of the body, arm and end effector being shown overlaying one another during this process.

In the example of FIG. 2A, an end effector 202 is to be moved from left to right and the body 201 remains stationary. As described above, such an approach can lead to kinematic limitations such as hyperextension, which is depicted in FIG. 2A by the portions 203 of the arm having to reach beyond a desired maximum extension when the end effector moves sufficiently far to the right.

In the example of FIG. 2B, which corresponds to the ‘follow the hand’ approach described above, the body 211 always moves with the end effector 212 so that, as the end effector moves to the right, the body also moves to the right in the same manner. As described above, while this approach may avoid limitations such as hyperextension or collisions, such movement is undesirable because the repeated and unnecessary movements of the body may lead to instability of the robot and/or may be less aesthetically pleasing.

In the example of FIG. 2C, the body 221 rotates clockwise and moves up and to the right an amount sufficient to avoid hyperextension of the arm due to motion of the end effector to the right. As a result, hyperextension of the arm is avoided while minimizing movement of the body and also avoiding the undesirable excess motion of the ‘follow the hand’ approach. Techniques to determine the motion of the body that implement this approach are described below.

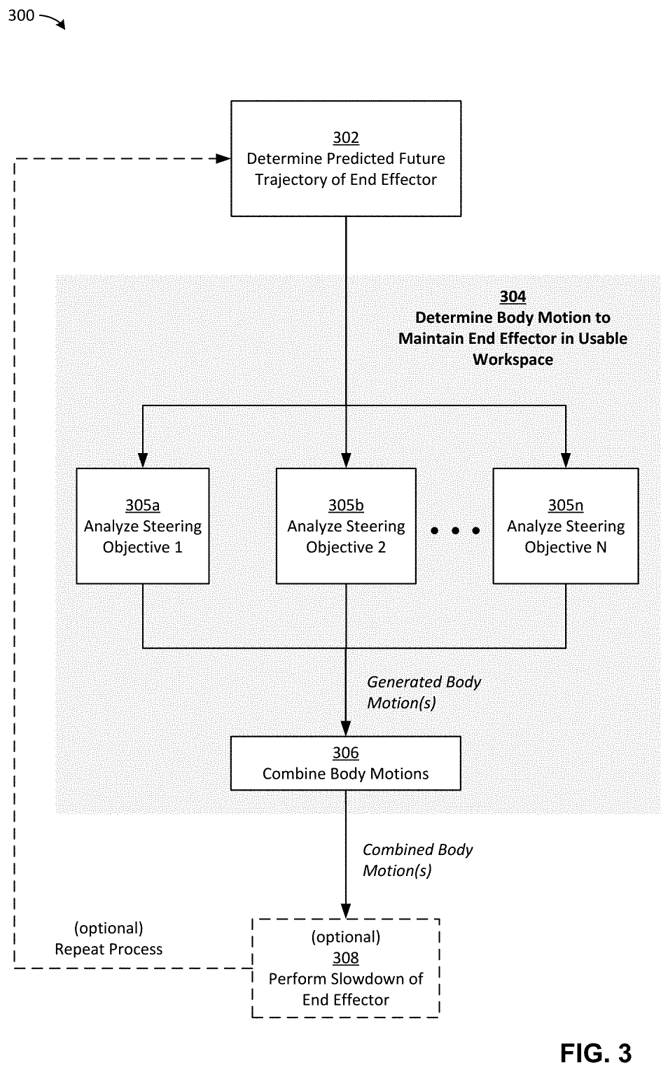

FIG. 3 is a flowchart of a method 300 of controlling a robot by determining a motion of the robot's body that will maintain the end effector within a useable workspace, according to some embodiments. Method 300 may be performed by one or more components of a robot (e.g., one or more controllers) to generate one or more body motions for the robot. The generated body motion(s) can be supplied to or otherwise be accessed by one or more components of the robot configured to move the robot based on the generated body motion. In some cases, the robot may include several steering units, including one steering unit configured to perform steering of the robot based on the body motion generated by method 300. Other steering units may include a collision avoidance steering unit that works in concert with the other steering units so that, if body motion for the robot is generated in response to performing method 300, the robot may attempt to move as indicated by this body motion while also avoiding obstacles.

According to some embodiments, method 300 may be performed by a robot before and/or during performance of a task. In some cases, the task may be a constrained manipulation task including, but not limited to, opening a door or cabinet, turning a handle or crank, or pulling open a drawer. Method 300 may be performed repeatedly (as noted by the optional path returning to act 302 from act 308) during a task to predict a future trajectory of the end effector and generate any body motion necessary to maintain the end effector within a useable workspace. In some cases, acts 302, 305a . . . n, and 306 (and optionally act 308) may be performed at regular intervals, such as once every 1-10 milliseconds.

Method 300 begins with act 302 in which a predicted future trajectory of an end effector of a robot is determined. The predicted future trajectory may be described in any suitable way, including by a plurality of data points indicating position and/or orientation (or pose) data of the end effector at various times in the future, and/or by velocity and acceleration vectors (e.g., a velocity vector and an acceleration vector, linear or angular as appropriate, for each degree of freedom). In some cases, the predicted future trajectory may comprise a plurality of SE(3) data points describing the pose of the end effector over time, e.g., for a period of seconds into the future, such as between 1 and 2 seconds.

In some embodiments, the predicted future trajectory may be determined based on stored data indicating prior positions, orientations, or poses of the end effector. In some cases, data indicating a plurality of prior poses of the end effector may be accessed (e.g., from a computer readable storage medium of the robot) and analyzed to predict a future trajectory of the end effector. For instance, the prior poses may be fit to a path, and the path may be extrapolated to determine future expected poses of the end effector. Such a fit may fit both position and orientation (e.g., SE(3) data points) of the end effector to the path. The path may be any suitable parametrizable path including lines, circles, and/or higher order curves.

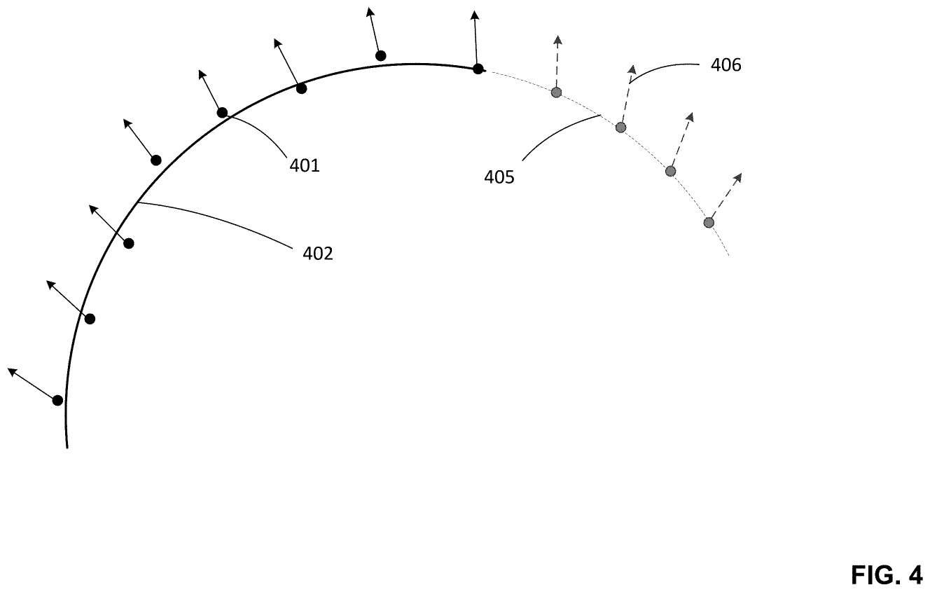

As an example of this approach, FIG. 4 depicts the position and orientation of an end effector in two dimensions, with the location of data points 401 representing prior positions of the end effector and associated arrows that indicate prior orientations (e.g., heading) of the end effector. The poses represented by data points 401 may be fit to a circle 402 to extrapolate a predicted future trajectory of the end effector 405 that includes predicted positions and orientations of the end effector in the future as represented by predicted data points 406. In some embodiments, the predicted future trajectory of an end effector of a robot may be determined in act 302 under an assumption that the velocity of the end effector is constant.

Returning to FIG. 3, according to some embodiments, the predicted future trajectory of an end effector of a robot may be determined in act 302, at least in part, based on a type of task being performed. Since the robot may be instructed to perform a particular known task, a path shape of the future trajectory may be predictable to some extent (and may be predictable to a greater extent at sooner future times compared with later future times). For instance, when instructed to open a door using its handle, it may be assumed in act 302 that the path taken by the end effector will be circular. The expected shape of the path may be input to the process described above to select an appropriate path to which data points are fit. In some embodiments, a predicted future trajectory may be obtained or otherwise derived from stored data describing a previous time when the current task was performed. For instance, when opening a door that was previously opened by the same robot, data indicating the pose of the end effector over time during the initial opening of the door may be accessed and used as (or used to derive) the predicted future trajectory for the present opening task.

According to some embodiments, the predicted future trajectory of an end effector of a robot may be determined in act 302, at least in part, by obtaining data describing a physical space proximate to the robot and predicting a path that will be followed through it. For instance, image data and/or other data describing the environment (e.g., LIDAR data) may be analyzed to predict where the end effector will move during a particular task. A location of a door handle may be imaged or otherwise measured, for example, and the path of the door handle when the door is opened may be predicted. Consequently, a path of the end effector holding the door handle may also be determined.

According to some embodiments, the predicted future trajectory of an end effector of a robot may be determined in act 302, at least in part, based on a current velocity of the end effector. The velocity may be measured by the robot (e.g., using an accelerometer or other suitable device) or may be inferred from prior motion of the end effector. It will be appreciated that the ‘current’ velocity need not necessarily be determined at the same instant as the predicted future trajectory is determined, but may be determined within a short amount of time (e.g., within a millisecond) prior to determining the trajectory and still be considered a ‘current’ velocity. Using the current velocity of the end effector to determine the predicted future trajectory may cause the trajectory to naturally ‘decay’ when the end effector slows down, with the extent of the trajectory into the future becoming smaller as the velocity of the end effector decreases.

More generally, it may be appreciated that the word “current” as used herein to refer to data describing, for example, a current pose, a current velocity, a current position, a current orientation, etc. need not necessarily be determined at the same instant as the data is utilized to make a calculation. In practice, there may be a short delay between determining a “current” value of some kind and utilizing this value in a calculation or other analysis. In some embodiments, “current” may simply refer to a most recently determined indication of an associated value. For example, a “current pose” of the body may refer to a pose of the body determined a short time (e.g., less than 1 ms) ago, or may refer to a most recently determined pose of the body.

According to some embodiments, the predicted future trajectory of an end effector of a robot may be determined in act 302, at least in part, by enforcing an end stop on the trajectory based on a task being performed. Since some tasks may be expected to have an end point (e.g., a fully open door when opening a door), an end point location may be determined based on data indicating an expected range of motion of the end effector. The trajectory may be then generated with an end stop at this end point location, such as by determining a predicted future trajectory via any of the technique(s) described above and cutting off a portion of the trajectory that extends beyond the end point location, or by any other suitable process.

Once the predicted future trajectory of the end effector is determined in act 302, body motion required to maintain the end effector in a usable workspace is determined in act 304 of method 300. In the example of FIG. 3, act 304 includes a plurality of acts 305a, 305b, . . . , 305n, each of which analyze a different steering objective based on the predicted future trajectory to determine body motion that will meet one or more constraints associated with the respective steering objective. In some embodiments, the steering objectives may be analyzed based on poses of the end effector described by the predicted future trajectory of the end effector. In some embodiments, one or more of acts 305a, 305b, . . . , 305n may analyze a respective steering objective based on a given (e.g., current) pose of the body of the robot. Determined body motions generated by the different analyses are combined in act 306, as will be described further below. It will be appreciated that in some implementations only a single steering objective may be analyzed, in which case act 306 may be unnecessary since only a single body motion may be generated by the single analysis. However, FIG. 3 is provided as an example of there being multiple steering objective analyses for purposes of explanation.

A steering objective, as used herein, refers to one or more constraints upon the combination of end effector pose and/or body pose of the robot and/or upon relative positions (e.g., joint angles) of different joints within the articulated arm that comprises the end effector. Each of acts 305a, 305b, . . . , 305n may determine, for a given steering objective, any body motion of the robot that would be necessary to obey the constraint(s) associated with the steering objective. The different steering objective analyses may determine body motions that relate to the same type of motion of the body, or may determine body motions that relate to different types of motion of the body. For instance, one steering objective analysis may determine a translational motion of the body, whereas another steering objective analysis may determine a rotational motion of the body. Similarly, one steering objective analysis may determine a motion of the body centered around one point on the body, whereas another steering objective analysis may determine a motion of the body centered around a different point of the body.

Body motion generated by one of acts 305a, 305b, . . . , 305n may be expressed in any suitable way, including as a trajectory indicating a position and/or velocity of the body (or some part of the body) at a plurality of points in time. Positions and velocities in such a trajectory may be represented by linear velocity magnitudes at a given point, rotational velocity magnitudes around a given axis, velocity vectors, or combinations thereof. In some embodiments, body motion generated by any one or more of acts 305a, 305b, . . . , 305n may be a trajectory comprising a plurality of points in SE(2) space and/or a plurality of points in SE(3) space. In some embodiments, body motion generated by any one or more of acts 305a, 305b, . . . , 305n may comprise a desired instantaneous velocity of the body for a given point in time. Such an instantaneous velocity may be integrated over a time step to determine an expected pose of the body at a subsequent time step, and acts 305a, 305b, . . . , 305n repeated for the subsequent time step, etc. as described further below.

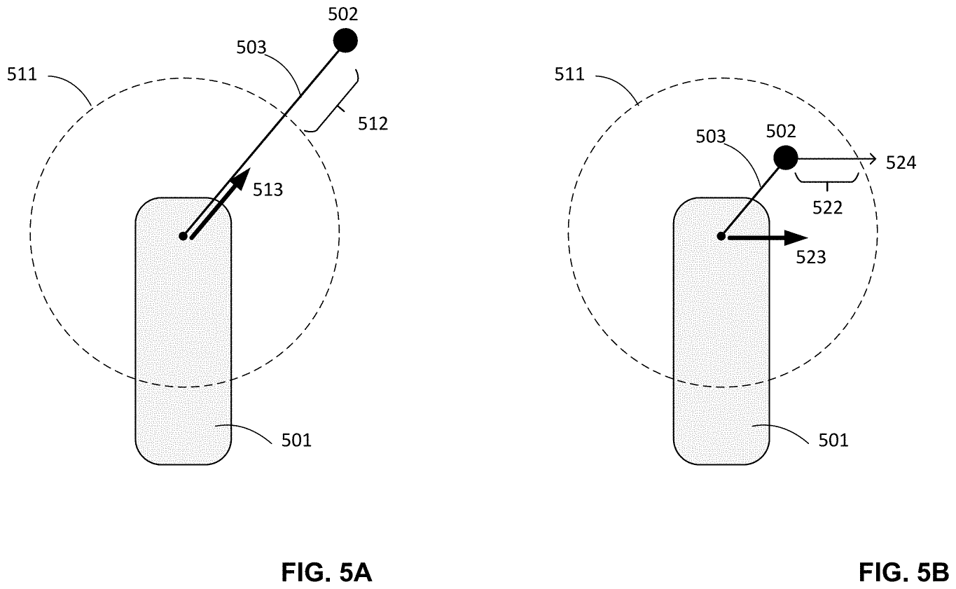

Illustrative examples of suitable steering objectives and their associated analyses are described further below in relation to FIGS. 5A-5B, 6, 7, 8 and 9. These illustrative steering objectives are summarized in Table 1, below.

TABLE 1

| | Associated | |
|---|---|---|
| Steering Objective | FIG(S). | Type of Body Motion Generated |
| Avoid Arm Hyperextension | 5A-5B | Translational Velocity at Shoulder |
| Avoid End Effector/Body Collision | 6 | Translational Velocity at Contact Point |
| Avoid Arm Joint Limit | 7 | Translational Velocity at Shoulder |
| Avoid “No-Go” Region | 8 | Translational Velocity at Shoulder |
| Align Heading to Body Motion | 9 | Yaw Rotation About Body Center |

According to some embodiments, the steering objective analyses in acts 305a, 305b, . . . , 305n, may be performed independently of one another. That is, each analysis may generate body motion independently of any body motions that may (or may not) be generated by any of the other analyses. In some embodiments, however, a given steering objective analysis may utilize output from another steering objective analysis, which may include an intermediate result produced by the analysis, and/or body motion determined by the analysis.

The body motions generated by each of the one or more steering objective analyses 305a, 305b, . . . , 305n may be combined in act 306. In some embodiments, act 306 may comprise generating one or more body motions that represent a combination of body motions generated by each of the one or more steering objective analyses. In some cases, one or more of the body motions generated by each of the one or more steering objective analyses may be summed to produce a net body motion velocity (e.g., through vector addition or otherwise). When each body motion generated by the one or more steering objective analyses is described by a trajectory, velocities at each point along the trajectories may be individually combined (e.g., through vector addition or otherwise) to produce a combined trajectory.

In some embodiments, a body motion may be generated in act 304 in the following manner. First, a current body pose is obtained, and an end effector pose and velocity may be determined at an initial time t=0 from the predicted end effector trajectory (e.g., from a first data point in the trajectory). Acts 305a, 305b, . . . , 305n may then each be performed for the end effector pose and velocity at t=0 to generate a desired instantaneous velocity of the body for that time point. The velocities generated from acts 305a, 305b, 305n may be combined (e.g., summed) to produce a single body velocity in act 308. This velocity may be integrated over to a predetermined time step dt to find the body pose expected at time t=dt. The above process may then be repeated for the next time step by taking the expected body at time t=dt and the end effector pose and velocity expected at time t=dt from the predicted end effector trajectory. Acts 305a, 305b, . . . , 305n may then each be performed for the end effector pose and velocity at t=dt to generate a desired instantaneous velocity of the body for that time point, which may be combined to produce a single body velocity in act 308 for time t=dt. This velocity may be integrated over to a predetermined time step dt to find the body pose expected at time t=2dt. By repeating this process, acts 305a, 305b, . . . , 305n and 308 may be performed many times to build up a trajectory of the body based on the predicted future trajectory of the end effector, with these acts being performed multiple times each time a new predicted future trajectory of the end effector is determined in act 302.

In some embodiments, body motions that relate to different types of motion of the body may be combined in act 306, in which case like types of motion may be combined to produce a combined body motion for each type. For example, one or more body motions generated by the steering objective analyses 305a, 305b, . . . , 305n that relate to a first type of motion (e.g., translational) may be combined to produce a first combined body motion in act 306, and in addition one or more body motions generated by the steering objective analyses that relate to a second type of motion (e.g., rotational) may be combined to produce a second combined body motion in act 306.

In some embodiments, a steering limit may be applied to one or more of the combined body motion(s) produced by act 306. For instance, if the combined body motion would suggest moving the body faster than some limit, the combined body motion may be reduced to this limit so that the robot does not try to move the body at a rate that would exceed the limit. In some cases, a portion of a trajectory that represents the combined body motion may be reduced to the limit while other portions of the trajectory, which are under the limit, remain unchanged. A velocity limit may be based on the maximum physical speed at which the body can be moved, a safety limit, and/or any other suitable limit.

According to some embodiments, the combined body motion(s) produced by act 306 based on the predicted trajectory of the end effector may be provided to a module of the robot to move the robot according to the combined body motion(s). In some cases, other steerers may also be operated by the robot in conjunction with the module receiving the combined body motion(s) produced by act 306.

Optionally, in act 308 the one or more components of a robot performing method 300 may determine whether the combined body motion(s) will meet all (or some selected subset of) the steering objectives based on the predicted future trajectory of the end effector and, if at least one steering objective cannot be met, initiate a process of slowing down the end effector. As one example, if the one or more components of the robot are unable to generate combined body motion(s) that would stop the end effector from colliding with the body, slowing down the end effector to avoid the collision may be desirable. In some embodiments, act 308 may comprise generating an expected trajectory of the body of the robot based on the combined body motion(s) generated in act 306. In other embodiments, act 306 may supply such trajectories to act 308 for analysis.

According to some embodiments, in act 308 the one or more components of a robot performing method 300 may determine whether the combined body motion(s) will violate one or more physical constraints, in addition to, or alternatively to, determining whether the combined body motion(s) will meet all the steering objectives as described above. Since some of the steering objectives may not be met in a binary fashion, it may be preferable for some steering objectives to consider whether any physical constraints will be violated instead of determining if the steering objective will be met or not. For example, aligning robot heading with a direction of motion as discussed further below may sometimes not be met, but since this steering objective can be viewed as more of a goal rather than a necessity (compared, say, with a steering objective not to collide the end effector with the body), it may be preferable to slowdown the end effector based on this steering objective only when some more significant physical constraint is violated instead.

According to some embodiments, slowing down the end effector in act 308 may comprise reducing the velocity of the end effector by a fixed amount (e.g., by signaling a steerer or other controller configured to control the end effector to reduce its velocity). In some embodiments, slowing down the end effector in act 308 may be gradual such that the velocity is gradually reduced over time rather than inducing a single change in the velocity.

According to some embodiments, slowing down the end effector in act 308 may comprise activating a slowdown flag that will reduce the velocity of the end effector by a fixed amount during each iteration of method 300 so long as the slowdown flag is activated. Repeated instances of act 308 may determine whether the combined body motion(s) will meet all the steering objectives based on the predicted future trajectory of the end effector with a lower velocity. Once all the steering objectives can be met, the slowdown flag may be deactivated in act 308. As a result, the velocity may repeatedly be decreased by small steps until the steering objectives can be met. In some embodiments, the slowdown flag may also be deactivated if the velocity of the end effector reaches or falls below a minimum threshold value to avoid operating motors at an undesirable speed.

Irrespective of whether or not method 300 includes act 308, the acts 302, 305a . . . n, and 306 (and optionally act 308) may be repeated, including at regular intervals as described above.

In some embodiments, act 304 may be repeated one or more times for each time that act 302 is performed. For instance, a predicted future trajectory may be determined in act 302 and points within this trajectory sampled to determine a trajectory for the body motion, as discussed above.

FIGS. 5A-5B, 6, 7, 8 and 9 relate to illustrative examples of suitable steering objectives and their associated analyses, as described above. For each of the examples of FIGS. 5A-5B, 6, 7, 8 and 9, a predicted future trajectory of the end effector may be analyzed. In some embodiments, a desired trajectory for the body may be determined as a “generated body motion” in the context of FIG. 3 based on one or more of the described steering objectives. For instance, a desired velocity vector may be determined for the body based on one or more of the steering objectives for each of a plurality of points along the predicted future trajectory of the end effector. At each point in time along the predicted future trajectory of the end effector, a velocity vector for the body may be integrated to produce a new expected body pose at a subsequent time step, thereby allowing determination of a desired velocity vector of the body at the subsequent time step. By repeating this process as described above, a trajectory of the body over time may be generated. For simplicity, each approach of FIGS. 5A-5B, 6, 7, 8 and 9 is considered in two dimensions, though each could be extended to three dimensions as well.

FIGS. 5A and 5B depict two approaches to determining body motion to avoid arm hyperextension, according to some embodiments. In the example of FIGS. 5A-5B, a robot is represented pictorially by a body 501 (rounded rectangle) coupled to an end effector 502 (large black circle) via an articulated arm 503 (the line connecting the body to the end effector). In the hyperextension analysis, the constraint may be to avoid the end effector going outside a useable workspace represented by circle 511, which would mean that the arm may be exceeding some mechanical limit (or at least passing a desired limit that may otherwise affect function). In some embodiments, a desired limit may differ from a mechanical limit by a buffer or “padding” parameter, which in real-world settings can provide additional insurance that the mechanical limit is not inadvertently exceeded due to unforeseen errors (e.g., in sensing, computation, unexpected environmental changes, etc.).

In the example of FIG. 5A, hyperextension is analyzed by determining whether the arm length exceeds a threshold. In the context of the method 300 and analyzing a steering objective based on a predicted future trajectory of the end effector, determining whether the arm length exceeds a threshold may be based on any part of the predicted trajectory. As such, the configuration of FIG. 5A may represent a position of the end effector 502 relative to body 501 a very short time in the future (e.g., within a few milliseconds) or may represent a position of the end effector 502 relative to body 501 a longer time into the future (e.g., 1-2 seconds), or anywhere in-between.

As shown in FIG. 5A, the arm 503 exceeds a maximum length represented by circle 511 by an amount 512. A resulting desired velocity of the body 513 may be generated based on the length of 512 so that the more the arm exceeds the threshold, the greater the velocity of the body becomes. In some embodiments, the velocity of the body may be calculated to be in a direction along the direction of the arm. In some embodiments, the velocity of the body may be calculated using a potential function based on the length of the excess extension 512.

As described above, this analysis may be performed for a plurality of points along the predicted future trajectory of the end effector so that a body velocity vector is generated for each of these points. The body velocity vectors may then be integrated as described above (and optionally combined with velocity vectors produced from the analysis of other steering objectives) to produce a trajectory of the body over time that avoids hyperextension of the arm.

In the example of FIG. 5B, hyperextension is analyzed by determining when the end effector will leave the usable workspace 511 based on its velocity vector 524. The distance 522 represents the distance between the end effector and the boundary of space 511 along the direction of the end effector's velocity vector. Based on the velocity magnitude and the distance 522, an expected time to reach the boundary of the useable workspace 511 may be determined. This expected time may be scaled via a suitable function (e.g., linear) to determine the magnitude of a desired velocity 523. In some embodiments, the velocity of the body may be calculated to be in a direction along the direction of the velocity vector 524, as shown in FIG. 5B.

According to some embodiments, either one of the approaches shown in FIGS. 5A and 5B may be performed as a steering objective analysis as described above. For instance, the approach of FIG. 5A may be performed as act 305a shown in FIG. 3.

In some embodiments, both of the approaches shown in FIGS. 5A and 5B may be performed for a plurality of points along a predicted future trajectory of the end effector. The resulting velocity vectors from each of the two approaches may be summed together to produce a single velocity vector for a given point along the predicted future trajectory of the end effector. The body velocity vectors may then be integrated as described above (and optionally combined with velocity vectors produced from the analysis of other steering objectives) to produce a trajectory of the body over time.

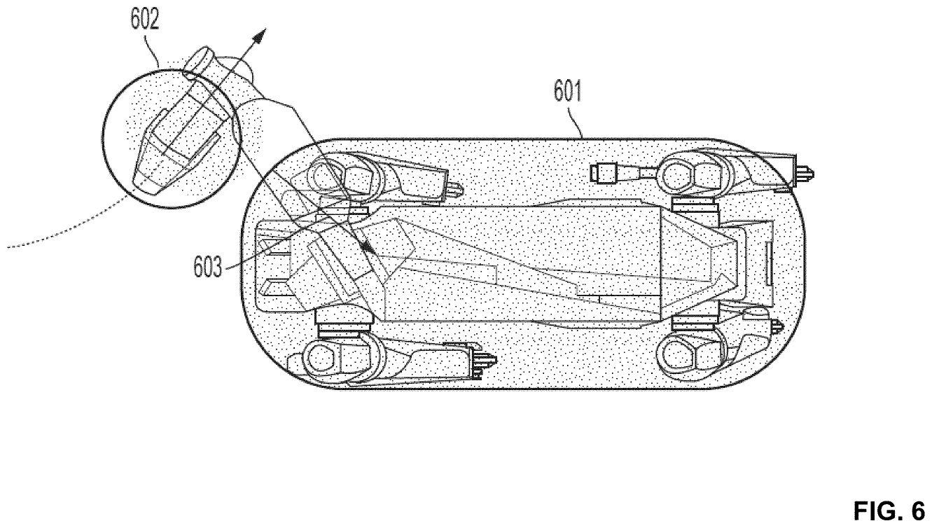

FIG. 6 depicts an approach to determining body motion to avoid end effector and body collisions, according to some embodiments. In the example of FIG. 6, which shows a view from above a robot, the body and end effector of the robot are represented, respectively, by simple geometries of a pill shape 601 and a sphere 602. The pill shape may have a rounded top or, for simpler analysis, could have the same two-dimensional cross-section shown in FIG. 6 at all points along the height axis (into the page of FIG. 6). It may be noted that in FIG. 6, a portion of a leg of the robot shown is depicted at the upper right of the drawing and extending outside of the pill shape 601. However, this portion of the leg is not part of the body of the illustrative robot shown in the figure.

For a plurality of points along the predicted future trajectory of the end effector, a velocity of the body may be determined so that the body avoids collisions with the end effector. In some embodiments, the velocity of the body for each point in the end effector trajectory may be calculated using a potential field based on a distance between the two shapes so that the smaller the distance between the shapes, the greater the velocity. In some embodiments, the velocity of the body may be calculated to be in a direction along the shortest path between the two geometrical shapes and away from the end effector, as shown by velocity vector 603 in the example of FIG. 6.

The above analysis may be performed for a plurality of points along the predicted future trajectory of the end effector so that a body velocity vector is generated for each of these points. The body velocity vectors may then be integrated as described above (and optionally combined with velocity vectors produced from the analysis of other steering objectives) to produce a trajectory of the body over time that avoids end effector and body collisions.

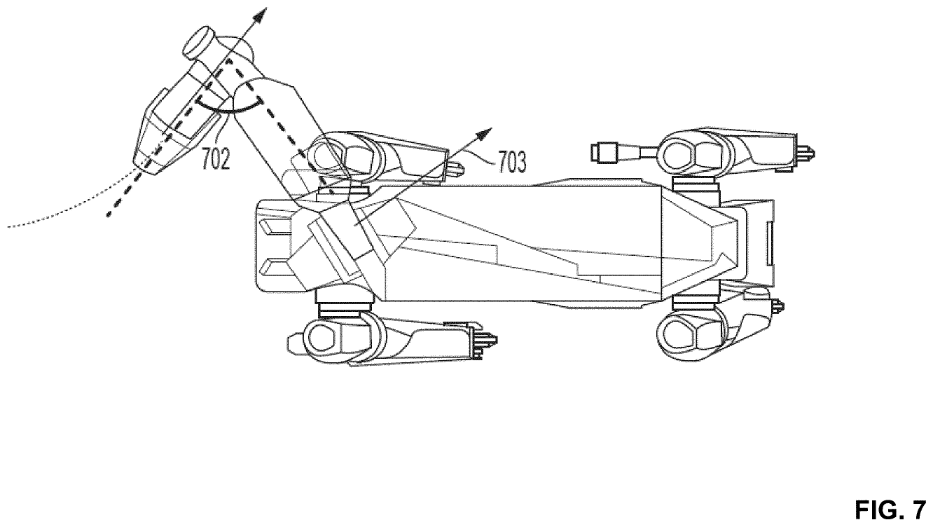

FIG. 7 depicts an approach to determining body motion to avoid reaching a joint limit of an articulated arm, according to some embodiments. Joints within an articulated arm may reach a limit of being unable to move further in a given direction, which may inhibit a task from being completed (e.g., because the end effector is unable to reach a desired pose as a result). In some cases, motion of the body may alleviate such a limit. In the example of FIG. 7, a joint angle 702 is depicted for purposes of illustration.

In the illustrative approach of FIG. 7, a velocity direction 703 for the body may be determined for each of a plurality of points along the predicted future trajectory of the end effector in the following manner. First, an inverse kinematics analysis is performed to determine the various joint configurations that may allow for the pose of the end effector at the considered point in the trajectory. A preferred joint configuration may be selected from among the possible configurations, and this configuration may be examined to determine whether the joints in the configuration are nearing a limit. When a joint is near to a limit (e.g., below or above some threshold), a relationship (e.g., a Jacobian) between the motion of that joint angle to motion of the body at the shoulder is determined, assuming the end effector is fixed in space. The vector from this relationship that represents shoulder motion may then be projected onto the x-y plane and used as the direction of the body velocity.

According to some embodiments, a magnitude of the velocity 703 of the body for each of a plurality of points along the predicted future trajectory of the end effector may be determined from a potential function of an angular distance between a given (e.g., current) joint position and a joint limit of the joint.

The above analysis may be performed for a plurality of points along the predicted future trajectory of the end effector so that a body velocity vector is generated for each of these points. The body velocity vectors may then be integrated as described above (and optionally combined with velocity vectors produced from the analysis of other steering objectives) to produce a trajectory of the body over time that avoids reaching a joint limit.

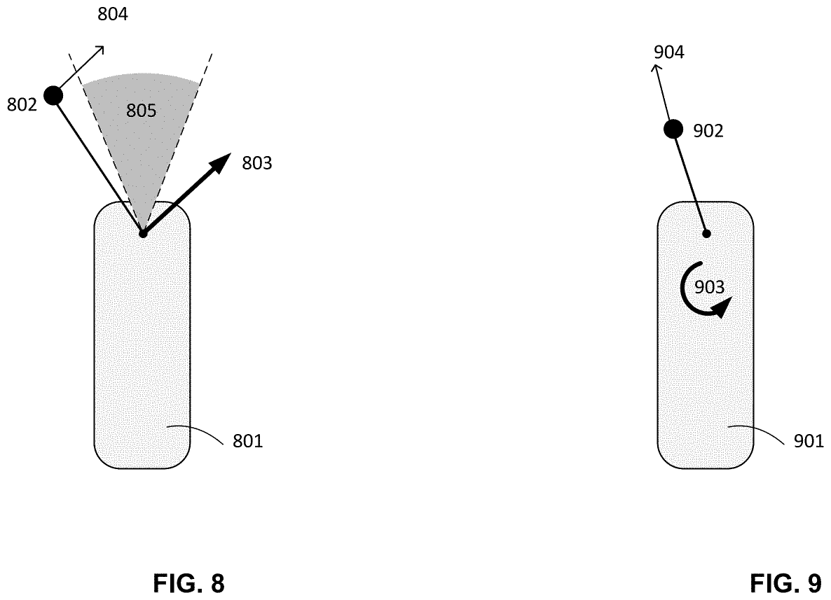

FIG. 8 depicts an approach to determining body motion to avoid an end effector entering a “no-go” region, according to some embodiments. In some cases, there may be volumes of space around a robot that it is preferable that the end effector avoids. As an example, a robot may include a camera or other sensor and it may be preferable for the end effector to avoid entering the volume directly in front of the sensor.

In the example of FIG. 8, a robot is represented pictorially by a body 801 (rounded rectangle) coupled to an end effector 802 (large black circle) via an articulated arm (the line connecting the body to the end effector). In the “no-go” analysis, the constraint is to prevent the end effector from going inside the region 805. According to some embodiments, the region 805 may be computationally represented as a wedge shape as illustrated in FIG. 8 at all points along the height axis (into the page of FIG. 8).

For a plurality of points along the predicted future trajectory of the end effector, a velocity of the body may be determined so that the end effector avoids the “no-go” region 805. In some embodiments, the velocity of the body for each point in the end effector trajectory may be calculated using a potential field based on a distance between the end effector and the region 805 so that the smaller the distance between the end effector and region 805, the greater the velocity. In some embodiments, the velocity of the body may be calculated to be in a direction that is the same as the velocity of the end effector 804, as shown by velocity vector 803 in the example of FIG. 8.

The above analysis may be performed for a plurality of points along the predicted future trajectory of the end effector so that a body velocity vector is generated for each of these points. The body velocity vectors may then be integrated as described above (and optionally combined with velocity vectors produced from the analysis of other steering objectives) to produce a trajectory of the body over time that avoids the end effector entering a “no-go” region.

FIG. 9 depicts an approach to determining body motion to align a heading of the body to motion of the end effector, according to some embodiments. In some cases, it may be desirable for the robot to be facing the direction in which it is moving, since the robot may be the most stable when walking forward, compared with walking sideways or backwards. In some embodiments, one way to enforce this constraint is to control the heading of the body to align with the velocity of the end effector.

In the example of FIG. 9, a robot is represented pictorially by a body 901 (rounded rectangle) coupled to an end effector 902 (large black circle) via an articulated arm (the line connecting the body to the end effector). For a plurality of points along the predicted future trajectory of the end effector, a velocity of the body may be determined so that the body heading aligns with that of the end effector. In some embodiments, the velocity of the body for each point in the end effector trajectory may be calculated by comparing the current heading of the body with the heading of the end effector's velocity 904 in the x-y plane. The difference between the two headings may be scaled to a velocity magnitude for a rotation around the z-axis 903 as shown in FIG. 9.

In some embodiments, once the rotational velocity trajectory for the body is determined via the above-described approach, the analysis described above in relation to FIG. 6 may be performed (or a result from that analysis may be otherwise obtained) to confirm that the rotation 903 will not cause a collision between the end effector 902 and the body 901.

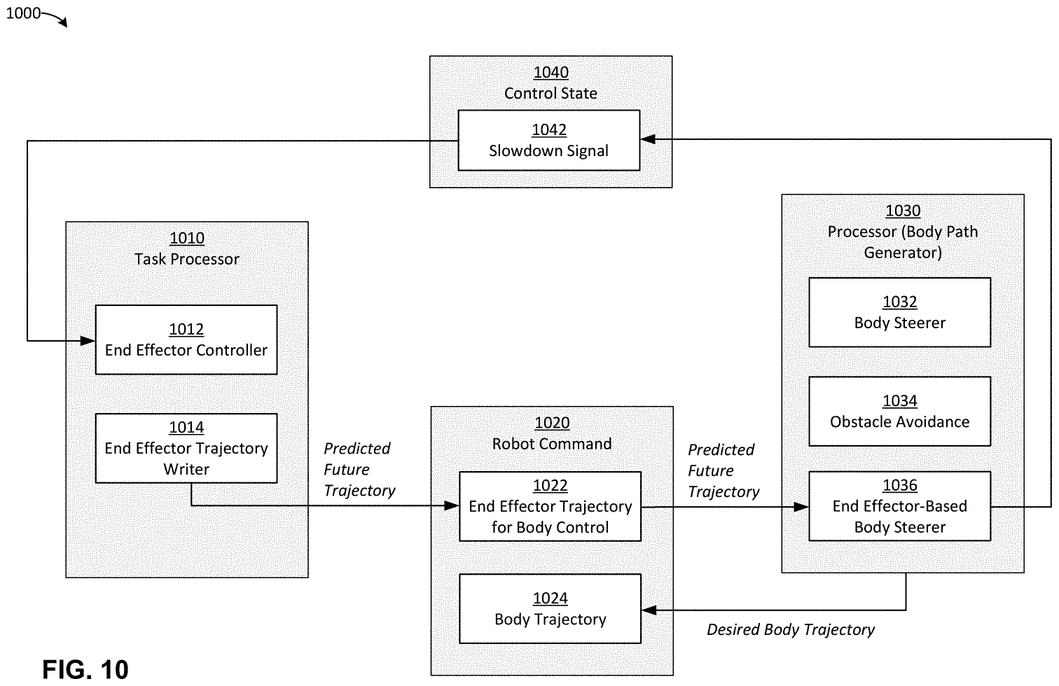

FIG. 10 is a schematic of a robotics system suitable for practicing embodiments of the present disclosure, according to some embodiments. In the example of FIG. 10, various operations of the robot as described below are performed by four modules: the task processor 1010, the robot command module 1020, the body path generator processor 1030 and the control state module 1040. It will be appreciated that a robotics system suitable for performing the techniques described herein may be configured in various ways, and that system 1000 is provided as merely one illustrative example configuration. Moreover, the units described below could be implemented in any number of modules with any number of processors, and are not limited to the particular example described.

In the example of FIG. 10, the task processor 1010 of system 1000 includes an end effector controller 1012, which may be configured to direct the end effector to perform tasks, which may include constrained tasks as described above. The end effector trajectory writer 1014 may be configured to generate a predicted future trajectory of the end effector during a task, as described above, and write the generated trajectory to the end effector trajectory for body control unit 1022.

The body path generator module 1030 may be configured to determine an appropriate body path for the robot based on a set of steerers. In one exemplary embodiment, three steerers are used: body steerer 1032, obstacle avoidance steerer 1034, and end effector-based body steerer 1036. The body steerer 1032 may, for instance, generate a velocity for a robot or otherwise generate a manner in which to physically move the robot based on a desired path of motion. The obstacle avoidance steerer 1034 may be configured to determine adjustments to the motion that may be necessary given surrounding obstacles (e.g., in part from one or more sensors of the robot). The end effector-based body steerer unit 1036 may be configured to determine body motion that will maintain the end effector within a useable workspace based on the received predicted future trajectory of the end effector, as described above. In making this determination, the end effector-based body steerer unit 1036 may access the predicted future trajectory of the end effector from the end effector trajectory for body control unit 1022. The combination of these steerers may, for instance, allow the robot to make a desired body motion in response to the end effector's predicted future trajectory as described above, while also avoiding obstacles. The desired motion that results from the body path generator module is written to the body trajectory unit 1024.

In addition, a slowdown signal flag may be stored in the slowdown signal unit 1042, when the end effector-based body steerer 1036 determines to signal the end effector to reduce its velocity because at least one steering objective is determined not to be met, as described above in relation to act 308 in FIG. 3.

FIG. 11 illustrates an example configuration of a robotic device (or “robot”) 1100, according to some embodiments. The robotic device 1100 represents an illustrative robotic device configured to perform any of the techniques described herein. The robotic device 1100 may be configured to operate autonomously, semi-autonomously, and/or using directions provided by user(s), and may exist in various forms, such as a humanoid robot, biped, quadruped, or other mobile robot, among other examples. Furthermore, the robotic device 1100 may also be referred to as a robotic system, mobile robot, or robot, among other designations.

As shown in FIG. 11, the robotic device 1100 includes processor(s) 1102, data storage 1104, program instructions 1106, controller 1108, sensor(s) 1110, power source(s) 1112, mechanical components 1114, and electrical components 1116. The robotic device 1100 is shown for illustration purposes and may include more or fewer components without departing from the scope of the disclosure herein. The various components of robotic device 1100 may be connected in any manner, including via electronic communication means, e.g., wired or wireless connections. Further, in some examples, components of the robotic device 1100 may be positioned on multiple distinct physical entities rather on a single physical entity. Other example illustrations of robotic device 1100 may exist as well.

Processor(s) 1102 may operate as one or more general-purpose processor or special purpose processors (e.g., digital signal processors, application specific integrated circuits, etc.). The processor(s) 1102 can be configured to execute computer-readable program instructions 1106 that are stored in the data storage 1104 and are executable to provide the operations of the robotic device 1100 described herein. For instance, the program instructions 1106 may be executable to provide operations of controller 1108, where the controller 1108 may be configured to cause activation and/or deactivation of the mechanical components 1114 and the electrical components 1116. The processor(s) 1102 may operate and enable the robotic device 1100 to perform various functions, including the functions described herein.

The data storage 1104 may exist as various types of storage media, such as a memory. For example, the data storage 1104 may include or take the form of one or more non-transitory computer-readable storage media that can be read or accessed by processor(s) 1102. The one or more computer-readable storage media can include volatile and/or non-volatile storage components, such as optical, magnetic, organic or other memory or disc storage, which can be integrated in whole or in part with processor(s) 1102. In some implementations, the data storage 1104 can be implemented using a single physical device (e.g., one optical, magnetic, organic or other memory or disc storage unit), while in other implementations, the data storage 1104 can be implemented using two or more physical devices, which may communicate electronically (e.g., via wired or wireless communication). Further, in addition to the computer-readable program instructions 1106, the data storage 1104 may include additional data such as diagnostic data, among other possibilities.

The robotic device 1100 may include at least one controller 1108, which may interface with the robotic device 1100. The controller 1108 may serve as a link between portions of the robotic device 1100, such as a link between mechanical components 1114 and/or electrical components 1116. In some instances, the controller 1108 may serve as an interface between the robotic device 1100 and another computing device. Furthermore, the controller 1108 may serve as an interface between the robotic system 1100 and a user(s). The controller 1108 may include various components for communicating with the robotic device 1100, including one or more joysticks or buttons, among other features. The controller 1108 may perform other operations for the robotic device 1100 as well. Other examples of controllers may exist as well.

Additionally, the robotic device 1100 includes one or more sensor(s) 1110 such as image sensors, force sensors, proximity sensors, motion sensors, load sensors, position sensors, touch sensors, depth sensors, ultrasonic range sensors, and/or infrared sensors, or combinations thereof, among other possibilities. The sensor(s) 1110 may provide sensor data to the processor(s) 1102 to allow for appropriate interaction of the robotic system 1100 with the environment as well as monitoring of operation of the systems of the robotic device 1100. The sensor data may be used in evaluation of various factors for activation and deactivation of mechanical components 1114 and electrical components 1116 by controller 1108 and/or a computing system of the robotic device 1100.

The sensor(s) 1110 may provide information indicative of the environment of the robotic device for the controller 1108 and/or computing system to use to determine operations for the robotic device 1100. For example, the sensor(s) 1110 may capture data corresponding to the terrain of the environment or location of nearby objects, which may assist with environment recognition and navigation, etc. In an example configuration, the robotic device 1100 may include a sensor system that may include a camera, RADAR, LIDAR, time-of-flight camera, global positioning system (GPS) transceiver, and/or other sensors for capturing information of the environment of the robotic device 1100. The sensor(s) 1110 may monitor the environment in real-time and detect obstacles, elements of the terrain, weather conditions, temperature, and/or other parameters of the environment for the robotic device 1100.

Further, the robotic device 1100 may include other sensor(s) 1110 configured to receive information indicative of the state of the robotic device 1100, including sensor(s) 1110 that may monitor the state of the various components of the robotic device 1100. The sensor(s) 1110 may measure activity of systems of the robotic device 1100 and receive information based on the operation of the various features of the robotic device 1100, such as the operation of extendable legs, arms, or other mechanical and/or electrical features of the robotic device 1100. The sensor data provided by the sensors may enable the computing system of the robotic device 1100 to determine errors in operation as well as monitor overall functioning of components of the robotic device 1100.

For example, the computing system may use sensor data to determine the stability of the robotic device 1100 during operations as well as measurements related to power levels, communication activities, components that require repair, among other information. As an example configuration, the robotic device 1100 may include gyroscope(s), accelerometer(s), and/or other possible sensors to provide sensor data relating to the state of operation of the robotic device. Further, sensor(s) 1110 may also monitor the current state of a function, such as a gait, that the robotic system 1100 may currently be operating. Additionally, the sensor(s) 1110 may measure a distance between a given robotic leg of a robotic device and a center of mass of the robotic device. Other example uses for the sensor(s) 1110 may exist as well.

Additionally, the robotic device 1100 may also include one or more power source(s) 1112 configured to supply power to various components of the robotic device 1100. Among possible power systems, the robotic device 1100 may include a hydraulic system, electrical system, batteries, and/or other types of power systems. As an example illustration, the robotic device 1100 may include one or more batteries configured to provide power to components via a wired and/or wireless connection. Within examples, components of the mechanical components 1114 and electrical components 1116 may each connect to a different power source or may be powered by the same power source. Components of the robotic system 1100 may connect to multiple power sources as well.

Within example configurations, any suitable type of power source may be used to power the robotic device 1100, such as a gasoline and/or electric engine. Further, the power source(s) 1112 may charge using various types of charging, such as wired connections to an outside power source, wireless charging, combustion, or other examples. Other configurations may also be possible. Additionally, the robotic device 1100 may include a hydraulic system configured to provide power to the mechanical components 1114 using fluid power. Components of the robotic device 1100 may operate based on hydraulic fluid being transmitted throughout the hydraulic system to various hydraulic motors and hydraulic cylinders, for example. The hydraulic system of the robotic device 1100 may transfer a large amount of power through small tubes, flexible hoses, or other links between components of the robotic device 1100. Other power sources may be included within the robotic device 1100.

Mechanical components 1114 can represent hardware of the robotic system 1100 that may enable the robotic device 1100 to operate and perform physical functions. As a few examples, the robotic device 1100 may include actuator(s), extendable leg(s) (“legs”), arm(s), wheel(s), one or multiple structured bodies for housing the computing system or other components, and/or other mechanical components. The mechanical components 1114 may depend on the design of the robotic device 1100 and may also be based on the functions and/or tasks the robotic device 1100 may be configured to perform. As such, depending on the operation and functions of the robotic device 1100, different mechanical components 1114 may be available for the robotic device 1100 to utilize. In some examples, the robotic device 1100 may be configured to add and/or remove mechanical components 1114, which may involve assistance from a user and/or other robotic device. For example, the robotic device 1100 may be initially configured with four legs, but may be altered by a user or the robotic device 1100 to remove two of the four legs to operate as a biped. Other examples of mechanical components 1114 may be included.

The electrical components 1116 may include various components capable of processing, transferring, providing electrical charge or electric signals, for example. Among possible examples, the electrical components 1116 may include electrical wires, circuitry, and/or wireless communication transmitters and receivers to enable operations of the robotic device 1100. The electrical components 1116 may interwork with the mechanical components 1114 to enable the robotic device 1100 to perform various operations. The electrical components 1116 may be configured to provide power from the power source(s) 1112 to the various mechanical components 1114, for example. Further, the robotic device 1100 may include electric motors. Other examples of electrical components 1116 may exist as well.

In some implementations, the robotic device 1100 may also include communication link(s) 1118 configured to send and/or receive information. The communication link(s) 1118 may transmit data indicating the state of the various components of the robotic device 1100. For example, information read in by sensor(s) 1110 may be transmitted via the communication link(s) 1118 to a separate device. Other diagnostic information indicating the integrity or health of the power source(s) 1112, mechanical components 1114, electrical components 1118, processor(s) 1102, data storage 1104, and/or controller 1108 may be transmitted via the communication link(s) 1118 to an external communication device.

In some implementations, the robotic device 1100 may receive information at the communication link(s) 1118 that is processed by the processor(s) 1102. The received information may indicate data that is accessible by the processor(s) 1102 during execution of the program instructions 1106, for example. Further, the received information may change aspects of the controller 1108 that may affect the behavior of the mechanical components 1114 or the electrical components 1116. In some cases, the received information indicates a query requesting a particular piece of information (e.g., the operational state of one or more of the components of the robotic device 1100), and the processor(s) 1102 may subsequently transmit that particular piece of information back out the communication link(s) 1118.

In some cases, the communication link(s) 1118 include a wired connection. The robotic device 1100 may include one or more ports to interface the communication link(s) 1118 to an external device. The communication link(s) 1118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-described functions. The one or more controllers can be implemented in numerous ways, such as with dedicated hardware or with one or more processors programmed using microcode or software to perform the functions recited above.

Various aspects of the present technology may be used alone, in combination, or in a variety of arrangements not specifically described in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, some embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments in detail, various modifications and improvements will readily occur to those skilled in the art. Such modifications and improvements are intended to be within the spirit and scope of the technology. Accordingly, the foregoing description is by way of example only, and is not intended as limiting.

What is claimed is:

1. A method of controlling a robot comprising a body and an end effector coupled to the body, the method comprising:
using at least one processor:
obtaining a current pose of the body and a predicted future trajectory of the end effector;
determining, based at least in part on the current pose of the body and the predicted future trajectory of the end effector, a motion of the body that will maintain the end effector within a useable workspace; and
controlling the body to perform the motion.

2. The method of claim 1, wherein obtaining the predicted future trajectory comprises determining the predicted future trajectory based on data indicating one or more prior poses of the end effector.

3. The method of claim 2, wherein the one or more prior poses of the end effector are represented by data previously measured by the robot.

4. The method of claim 2, further comprising determining the predicted future trajectory by fitting the data indicating the one or more prior poses of the end effector to a line, circle, or curve.

5. The method of claim 2, further comprising determining the predicted future trajectory based on a type of task currently being performed.

6. The method of claim 2, wherein the predicted future trajectory is determined under an assumption that a velocity of the end effector is constant.

7. The method of claim 1, further comprising reducing a velocity of the end effector in response to determining that controlling the body to perform the motion while the end effector moves according to the predicted future trajectory will not maintain the end effector within the usable workspace.

8. The method of claim 1, wherein determining the motion of the body that will maintain the end effector within the useable workspace comprises determining motion of the body that meets a first steering objective when the end effector is moved along the predicted future trajectory.

9. The method of claim 8, wherein the first steering objective constrains a pose of the end effector relative to a pose of the body and/or constrains an angle of at least one of the one or more joints of an articulated arm that couples the end effector to the body.

10. The method of claim 9, wherein the first steering objective constrains the pose of the end effector relative to the pose of the body to:
avoid hyperextension of the articulated arm; and/or
avoid collisions between the end effector and the body.

11. The method of claim 8, wherein determining the motion of the body that will maintain the end effector within the useable workspace further comprises determining motion of the body that meets a second steering objective, different from the first steering objective, when the end effector is moved along the predicted future trajectory.

12. The method of claim 11, wherein determining the motion of the body that will maintain the end effector within the useable workspace comprises combining the determined motion of the body that meets the first steering objective with the determined motion of the body that meets the second steering objective.

13. The method of claim 1, further comprising determining the predicted future trajectory of the end effector while controlling motion of the end effector.

14. The method of claim 1, further comprising determining the predicted future trajectory based on a pose of the end effector and based on data describing an environment proximate to the end effector.

15. The method of claim 1, wherein the determined motion of the body that will maintain the end effector within the useable workspace is determined based on a pose of the end effector and/or a current velocity of the end effector.

16. The method of claim 1, wherein determining the motion of the body is further based on output from a collision avoidance system.

17. The method of claim 1, wherein determining the motion of the body that will maintain the end effector within the useable workspace comprises determining the motion of the body that will maintain the end effector within the useable workspace when the end effector is moved along the predicted future trajectory.

18. The method of claim 1, wherein controlling the body to perform the motion comprises controlling the body to perform the motion while the end effector moves according to the predicted future trajectory.

19. A mobile robotic device, comprising:
a body;
an end effector coupled to the body; and
at least one controller configured to:
obtain a current pose of the body and a predicted future trajectory of the end effector;
determine, based at least in part on the current pose of the body and the predicted future trajectory of the end effector, a motion of the body that will maintain the end effector within a useable workspace; and
control the body to perform the motion.

20. The mobile robotic device of claim 19, wherein the at least one controller is further configured to obtain the predicted future trajectory by determining the predicted future trajectory based on data indicating one or more prior poses of the end effector.

21. The mobile robotic device of claim 20, wherein the at least one controller is further configured to determine the predicted future trajectory by fitting the data indicating the one or more prior poses of the end effector to a line, circle, or curve.

22. The mobile robotic device of claim 20, wherein the at least one controller is further configured to determine the predicted future trajectory based on a type of task currently being performed.

23. The mobile robotic device of claim 19, wherein the at least one controller is further configured to reduce a velocity of the end effector in response to determining that controlling the body to perform the motion while the end effector moves according to the predicted future trajectory will not maintain the end effector within the usable workspace.

24. The mobile robotic device of claim 19, wherein determining the motion of the body that will maintain the end effector within the useable workspace comprises determining motion of the body that meets a first steering objective when the end effector is moved along the predicted future trajectory.

25. The mobile robotic device of claim 24, further comprising an articulated arm that couples the end effector to the body, and wherein the first steering objective constrains a pose of the end effector relative to a pose of the body and/or constrains an angle of at least one of the one or more joints of the articulated arm.

26. The mobile robotic device of claim 25, wherein the first steering objective constrains the pose of the end effector relative to the pose of the body to:
avoid hyperextension of the articulated arm; and/or
avoid collisions between the end effector and the body.

27. The mobile robotic device of claim 24, wherein determining the motion of the body that will maintain the end effector within the useable workspace further comprises determining motion of the body that meets a second steering objective, different from the first steering objective, when the end effector is moved along the predicted future trajectory.

28. The mobile robotic device of claim 27, wherein determining the motion of the body that will maintain the end effector within the useable workspace comprises combining the determined motion of the body that meets the first steering objective with the determined motion of the body that meets the second steering objective.

29. The mobile robotic device of claim 19, wherein the at least one controller is further configured to determine the predicted future trajectory of the end effector while controlling motion of the end effector.

30. The mobile robotic device of claim 19, wherein the at least one controller is further configured to determine the predicted future trajectory based on a pose of the end effector and based on data describing an environment proximate to the end effector.

31. The mobile robotic device of claim 19, wherein determining the motion of the body is further based on output from a collision avoidance system.

32. The mobile robotic device of claim 19, wherein determining the motion of the body that will maintain the end effector within the useable workspace comprises determining the motion of the body that will maintain the end effector within the useable workspace when the end effector is moved along the predicted future trajectory.

33. The mobile robotic device of claim 19, wherein the at least one controller is configured to control the body to perform the motion while the end effector moves according to the predicted future trajectory.
